(19) United States
(12) Patent Application Publication
(10) Pub. No.: US 2014/0202572 A1
(43) Pub. Date: Jul. 24, 2014

(54) AIR-FLOW CHANNEL FOR A VENTILATION DEVICE OF A MOTOR VEHICLE, AND A METHOD FOR PRODUCING SAME

(71) Applicants: Mirko Wiedemeyer, Dortmund (DE); Martin Kuckertz, Neuss (DE); Hans-Georg Werner, Langenfeld (DE); Antoine Kmeid, Koln (DE); Peter John Thurgood, Chelmsford Essex (GB); Bernd Gross, Langenfeld (DE)

(72) Inventors: Mirko Wiedemeyer, Dortmund (DE); Martin Kuckertz, Neuss (DE); Hans-Georg Werner, Langenfeld (DE); Antoine Kmeid, Koln (DE); Peter John Thurgood, Chelmsford Essex (GB); Bernd Gross, Langenfeld (DE)

(73) Assignee: JOHNSON CONTROLS INTERIORS GMBH & CO. KG, Grefrath (DE)

(21) Appl. No.: 14/126,474

(22) PCT Filed: Jun. 15, 2012
(86) PCT No.: PCT/EP2012/061453

§ 371 Date: Jan. 17, 2014

(30) Foreign Application Priority Data
Jun. 16, 2011 (DE) 102011077672.9

(51) Int. Cl. F16L 9/133

(52) U.S. Cl. CPC F16L 9/133
USPC 138/109; 138/170; 156/293

(57) ABSTRACT

The invention relates to an air-flow channel (1) for a ventilation device of a motor vehicle. According to the invention, a sealing element (7) is arranged in a bonded manner on at least one pipe opening (6) of the air-flow channel (1), in the region of an opening edge (2), said sealing element (7) being able to be arranged in the region of the opening edge (2) of the pipe opening (6), or applied onto said air-flow channel (1), by means of a fusing process or a thermal welding method such that the melted material of the sealing element (7) becomes joined to the heated material of the air-flow channel (1). The invention additionally relates to a method for producing an air-flow channel (1) for a ventilation device of a motor vehicle.

### BACKGROUND OF THE INVENTION

The invention relates to an air-flow channel for a ventilation device of a motor vehicle. The invention also relates to a method for producing an air-flow channel for a ventilation device of a motor vehicle.

DE 198 07 411 B4 describes an air-flow channel for a ventilation device of a motor vehicle as a tubular channel comprising shells of foam plastic with dimensional stability and shape elasticity that are connected at longitudinal edges by edge flanges lying against one another, at least one connecting piece and/or at least one connecting lug of polypropylene or polyethylene being attached at at least one tube opening of the air-flow channel, for stabilization and as a continuation of the same in the axial direction.

WO 2006/024316 A1 describes a method for connecting a layer of thermoplastic polymer to the surface of an elastomer. An expanded elastomer with preferably an open-cell surface is used. The thermoplastic layer is pressed against this surface while it is being heated up by thermal radiation, in particular laser light. The thermoplastic layer is transparent to these waves, while they are absorbed by the surface of the elastomer.

DE 10 2008 010 023 A1, DE 10 2004 049 398 A1 and DE 10 2006 016 483 A1 disclose further air channels, which have in transitional or connecting regions sealing sections in which sealing elements are arranged in a material-bonded manner.

### SUMMARY OF THE INVENTION

The present invention provides, in one aspect, an air-flow channel for a ventilation device of a motor vehicle. The air-flow channel includes a sealing element arranged in a material-bonded manner with at least one tube opening of the air-flow channel in the region of an opening periphery. The sealing element can be one of arranged in the region of the opening periphery of the tube opening and applied to the air-flow channel by one of a fusing process and a thermal welding method in such a way that the melted material of the sealing element becomes connected to the heated material of the air-flow channel.

The object of the present invention is to provide an air-flow channel for a ventilation device of a motor vehicle that is improved in comparison with the prior art and to provide an improved method for producing an air-flow channel for a ventilation device of a motor vehicle.

In the case of the air-flow channel for a ventilation device of a motor vehicle, a sealing element is arranged in a material-bonded manner at least one tube opening of the air-flow channel, in the region of an opening periphery, the sealing element being able to be arranged in the region of the opening periphery of the tube opening, or applied to the air-flow channel, by means of a fusing process or a thermal welding method in such a way that the melted material of the sealing element becomes connected to the heated material of the air-flow channel. As a result, the air-flow channel and at least one sealing element are connected to form a one-piece component, so that assembly of the component is made easier.

Particularly advantageously, the production costs of the air-flow channel with a sealing element are significantly reduced, since the number of components and the number of necessary production steps are reduced in comparison with the conventional production of an air-flow channel with a separate flange and sealing element.

The sealing element is expediently formed from a plastic with elastic properties and the air-flow channel is expediently formed from a plastic with thermoplastic properties.

In an advantageous embodiment, the sealing element is formed from an expanded plastic. As a result, a permanent sealing effect is made possible even under difficult conditions, such as for example vibrations and/or temperature fluctuations.

It is particularly preferred for the sealing element to be formed from a thermoplastic elastomer, in particular from what is known as TPE foam. Such a material can be thermoplastically processed well and has rubber-like properties.

In one possible embodiment, the air-flow channel is formed from polyolefin, in particular from a polyolefin foam, such as for example from polyethylene or polypropylene. Such a material is particularly suitable for being partially heated.

In a further embodiment, in addition to the sealing function of the sealing element and the material-bonded connection to the air-flow channel, it is provided that the sealing element is arranged on the air-flow channel with interlocking and/or frictional engagement. For the interlocking connection, the sealing element is applied to a barb-like formation or a protruding offset on the air-flow channel. For the frictional connection, the air-flow channel is slipped over a face, for example an end, of an adjacent further air-flow channel, the sealing element being arranged between the ends of the air-flow channels inserted one into the other and deformed, in particular pressed together, so that the sealing element presses against the ends and consequently lies against them with interlocking and/or frictional engagement.

With preference, the sealing element extends along the tube opening in a radially peripheral manner in the air-flow channel. This makes a particularly efficient sealing effect of the sealing element possible.

With particular preference, the sealing element is arranged on the inside in the region of the opening periphery. This allows a conventional flange of a further air-flow channel to be easily arranged in a sealed manner on or in the opening periphery.

In an alternative embodiment, the sealing element may be arranged on the outside in the region of the opening periphery.

The sealing element may advantageously have a round or polygonal cross section.

In a particularly advantageous embodiment, the sealing element is formed as a hollow profile. In this way, a weight reduction is made possible and the use of material necessary for producing the sealing element is reduced. Furthermore, such a sealing element is particularly flexible and has an improved thermal insulating effect.

In the case of the method for producing an air-flow channel for a ventilation device of a motor vehicle, according to the invention a sealing element is applied in a material-bonded manner to at least one tube opening of the air-flow channel in the region of an opening periphery. As a result, the air-flow channel and at least one sealing element are connected to form a one-piece component, so that production costs of the component are significantly reduced and assembly of the component is made easier.

With preference, the sealing element that can be formed from a thermoplastic elastomer is applied to the air-flow channel in a material-bonded manner by means of a fusing operation, so that a particularly durable connection between the air-flow channel and the sealing element is made possible. For the forming of the material-bonded connection, in one possible embodiment the air-flow channel is partially heated, for example by hot air, in the region of the sealing element to be applied and the molten material of the sealing element is applied, in particular injected, along the opening periphery of the air-flow channel.

The invention is explained in more detail on the basis of the appended schematic figures.

### BRIEF DESCRIPTION OF THE DRAWINGS

FIG. 1 schematically shows a sectional representation through an air-flow channel in the region of an opening periphery,

FIG. 2 schematically shows a sectional representation in the direction of a longitudinal extent of the air-flow channel in the region of an opening periphery,

FIG. 3 shows schematic cross-sectional variants of the sealing element,

FIG. 4 schematically shows a first configurational variant of an arrangement of a first air-flow channel on a further air-flow channel and

FIG. 5 schematically shows a second configurational variant of an arrangement of a first air-flow channel on a further air-flow channel.

Parts that correspond to one another are provided with the same reference numerals in all the figures.

### DETAILED DESCRIPTION

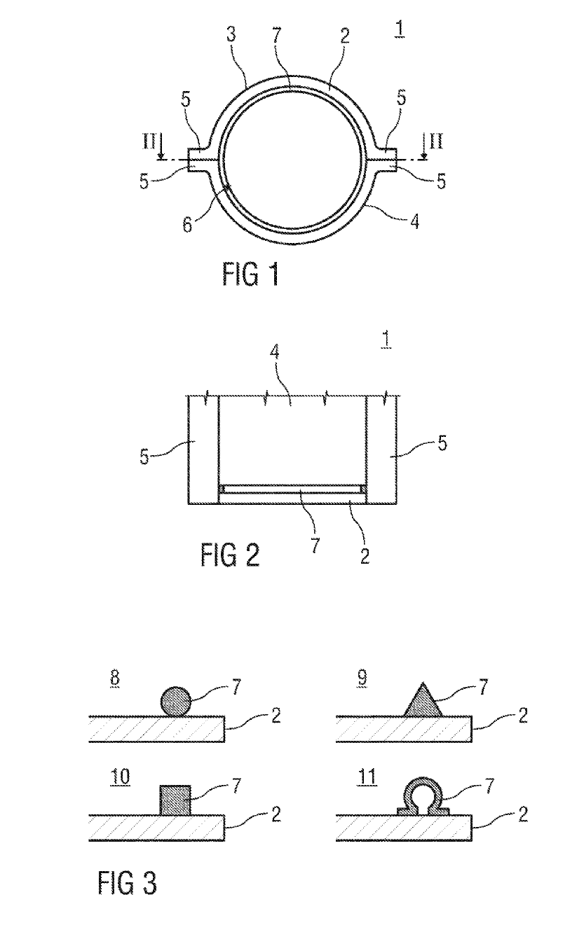

FIG. 1 schematically shows a sectional representation through an air-flow channel 1 in the region of an opening periphery 2.

The air-flow channel 1 is formed as a conventional air-flow channel for a ventilation device of a motor vehicle and is shaped for example as a tubular channel with a regular or irregular tube form.

The air-flow channel 1 is preferably produced in what is known as a two-shell type of construction, comprising two individual half-shells 3, 4, edge flanges 5 being arranged on the longitudinal edges of the half-shells 3, 4 and connected half-shells lying against one another. The edge flanges 5 of the half-shells 3, 4 are shaped so as to correspond to one another and are arranged against one another in such a way that they form a tubular cavity with at least two tube openings 6, for example an inlet and an outlet.

In this case, the half-shells 3, 4 are connected to one another with interlocking engagement, a material bond and/or frictional engagement, for example mechanically and/or thermally joined, for example welded, soldered, riveted or connected to one another in some other suitable way, at the edge flanges 5 arranged against one another of the half-shells 3, 4. With particular preference, the edge flanges 5 of the half-shells 3, 4 are joined in a material-bonded manner by means of a thermal welding operation.

The half-shells 3, 4 of the air-flow channel 1 consist for example of a thermoplastic material. In one possible embodiment, the half-shells 3, 4 are formed from polyolefin, in particular from polyethylene or polypropylene. For example, the half-shells 3, 4 are produced from a chemically crosslinked, closed-cell polyurethane foam with a surface formed as a skin, which is suitable for use in a temperature range from about −40° C. to about 100° C. and moreover has dimensional stability and shape elasticity.

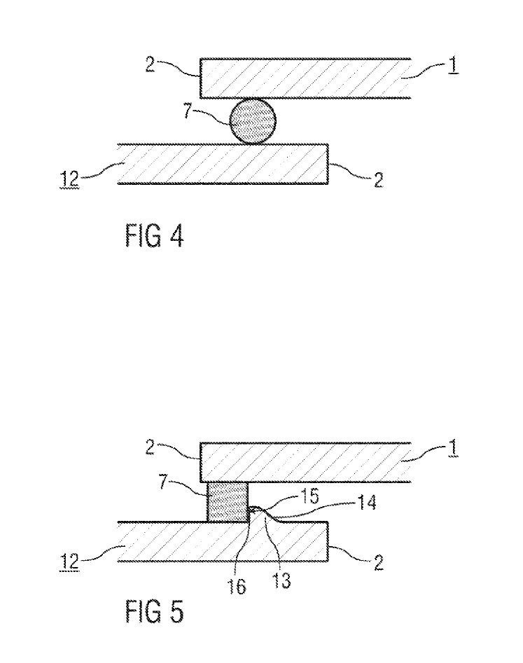

Each tube opening 6 comprises an opening periphery 2, to which a further air-flow channel 12, represented in FIGS. 4 and 5, can be coupled. In a configurational variant that is not represented, further components to be connected to the air-flow channel 1, for example ventilation openings and/or a grille, may be arranged at the opening periphery 2.

According to the invention, a sealing element 7 is arranged in a material-bonded manner at at least one tube opening 6 of the air-flow channel 1, in the region of an opening periphery 2. The sealing element in this case extends along the tube opening 6 in a radially peripheral manner in the air-flow channel 1.

In a first configurational variant, which is represented in FIG. 1, the sealing element 7 is arranged on the inside in the region of the opening periphery 2 in the air-flow channel 1.

In a second configurational variant, which is not represented, the sealing element 7 is arranged on the outside in the region of the opening periphery 2 on the air-flow channel 1.

The sealing element 7 is formed from an expanded and/or elastic plastic, the sealing element 7 advantageously being formed from a thermoplastic elastomer, in particular from what is known as a TPE foam.

FIG. 2 schematically shows a sectional representation along the sectional edge II-II, represented in FIG. 1, in the direction of a longitudinal extent of the air-flow channel 1 in the region of the opening periphery 2.

FIG. 3 schematically shows different cross-sectional variants of the sealing element 7. The sealing element 7 may have a round or polygonal cross section and be formed for example with a round cross section 8, a triangular cross section 9 or a square cross section 10.

Irrespective of the cross-sectional variant, the sealing element 7 may be formed as a solid profile or as a hollow profile 11.

During the production, the sealing element 7 that can be formed from a thermoplastic elastomer is applied to the air-flow channel 1 in a material-bonded manner by means of a conventional fusing operation.

A robot thereby guides a conventional extrusion die along the opening periphery 2 of the air-flow channel 1, while at the same time the opening periphery 2 is being partially heated by hot air in the region of the sealing element 7 to be applied. The molten material of the sealing element 7 coalesces with the heated material of the air-flow channel 1 and consequently forms a bond, which even after a short time is solid. This bond is advantageously so strong or can withstand such mechanical loads that the sealing element 7 can at the same time be used as a fixing element.

FIG. 4 schematically shows a first configurational variant of an arrangement of a first air-flow channel 1 on a further air-flow channel 12. In this case, an outer diameter of the opening periphery 2 of the first air-flow channel 1 is enlarged in comparison with the outer diameter of the opening periphery 2 of the further air-flow channel 12, so that the air-flow channels 1, 12 can be pushed one into the other at the ends. In order to seal the air-flow channels 1, 12 pushed one into the other, the sealing element 7 is arranged on the inside at the opening periphery 2 of the first air-flow channel 1. When the air-flow channels 1, 12 are being pushed one into the other, the elastic sealing element 7 is deformed in such a way that it lies with interlocking and/or frictional engagement against the outer side of the further air-flow channel 12 and seals the interior space of the air-flow channels 1, 12 with respect to the surroundings.

FIG. 5 schematically shows a second configurational variant of an arrangement of a first air-flow channel 1 on a further air-flow channel 12. This corresponds substantially to the first configurational variant as shown in FIG. 4, with the difference that a barb-like formation 13 is arranged at the opening periphery 2 of the further air-flow channel 12. This barb-like formation 13 comprises a rising section 14, along the course of which the outer diameter of the opening periphery 2 is enlarged, and a section 15 arranged at right angles or almost at right angles to the surface of the opening periphery 2, which connects the enlarged outer diameter and the surface of the opening periphery 2 while forming an offset 16.

In the assembled state of the air-flow channels 1, 12, the sealing element 7 is held against the offset 16 while forming an interlocking engagement.

Various features of the invention are set forth in the following claims.

1. An air-flow channel for a ventilation device of a motor vehicle, comprising:
a sealing element arranged in a material-bonded manner with at least one tube opening of the air-flow channel, in the region of an opening periphery,
wherein the sealing element can be one of arranged in the region of the opening periphery of the tube opening and applied to the air-flow channel by one of a fusing process and a thermal welding method in such a way that the melted material of the sealing element becomes connected to the heated material of the air-flow channel.

2. The air-flow channel as claimed in claim 1, wherein the sealing element is formed from a plastic with elastic properties and the air-flow channel is formed from a plastic with thermoplastic properties.

3. The air-flow channel as claimed in claim 1, wherein the sealing element is formed from an expanded plastic.

4. The air-flow channel as claimed in claim 1, wherein the sealing element is formed from a thermoplastic elastomer.

5. The air-flow channel as claimed in claim 1, wherein the air-flow channel is produced from polyolefin, in particular from polyethylene or polypropylene.

6. The air-flow channel as claimed in claim 1, wherein the sealing element extends along the tube opening in a radially peripheral manner in the air-flow channel.

7. The air-flow channel as claimed in claim 1, wherein the sealing element is arranged on one of inside and outside the air-flow channel in the region of the opening periphery.

8. The air-flow channel as claimed in claim 1, wherein the sealing element has one of a round and a polygonal cross section.

9. The air-flow channel as claimed in claim 1, wherein the sealing element is formed as a hollow profile.

10. The air-flow channel as claimed in claim 1, wherein the air-flow channel is configured as a two-part construction comprising two half-shells.

11. A method for producing an air-flow channel for a ventilation device of a motor vehicle, the method comprising:
applying a sealing element in a material-bonded manner to at least one tube opening of the air-flow channel in the region of an opening periphery by a fusing operation in such a way that the molten material of the sealing element coalesces with the heated material of the air-flow channel.

12. The method as claimed in claim 11, further comprising:
partially heating the air-flow channel by hot air in the region of the sealing element, and
injecting the molten material of the sealing element along the opening periphery.

13. The air-flow channel as claimed in claim 2, wherein the sealing element is formed from an expanded plastic.

14. The air-flow channel as claimed in claim 7, wherein the sealing element is arranged on the inside of the air-flow channel in the region of the opening periphery.

15. The air-flow channel as claimed in claim 14, wherein the air-flow channel is configured as a two-part construction comprising two half-shells.
